(19) United States
(12) Patent Application Publication
(10) Pub. No.: US 2014/0340382 A1
(43) Pub. Date: Nov. 20, 2014

(54) LIQUID CRYSTAL DISPLAY DEVICE, METHOD OF CONTROLLING LIQUID CRYSTAL DISPLAY DEVICE, CONTROL PROGRAM OF LIQUID CRYSTAL DISPLAY DEVICE, AND STORAGE MEDIUM FOR THE CONTROL PROGRAM

(71) Applicant: SHARP KABUSHIKI KAISHA, Osaka (JP)

(72) Inventors: Daiichi SAWABE, Osaka-shi (JP); Masanori NISHIDO, Osaka-shi (JP)

(73) Assignee: SHARP KABUSHIKI KAISHA, Osaka (JP)

(21) Appl. No.: 14/211,819

(22) Filed: Mar. 14, 2014

(30) Foreign Application Priority Data
May 17, 2013 (JP) 2013-105504

(51) Int. Cl. G09G 3/36

(52) U.S. Cl. CPC G09G 3/3696
USPC 345/212; 345/87

(57) ABSTRACT

While a power supply to a liquid crystal display device (100) is being turned off, a control circuit (2) sets a switching cycle of a gate bus line, via which writing is carried out, shorter than that during image display and carries out power-off processing in which a given voltage for power-off processing is applied to each source bus line. This makes it possible to provide, without greatly increasing a device cost, a liquid crystal display device capable of preventing a voltage from continuing to be applied to a pixel while the power supply is being turned off.

This Nonprovisional application claims priority under 35 U.S.C. §119 on Patent Application No. 2013-105504 filed in Japan on May 17, 2013, the entire contents of which are hereby incorporated by reference.

### TECHNICAL FIELD

The present invention relates to a technique for preventing a voltage from continuing to be applied to a pixel of a liquid crystal display device while a power supply to the liquid crystal display is being turned off.

### BACKGROUND ART

It has been conventionally known that, in a case where electric fields of identical polarities are continuously applied to pixels of a liquid crystal display device, polarization of liquid crystal molecules occurs, thereby causing a problem such as image sticking and a change in characteristic of a pixel. It has also been known that a phenomenon of image sticking occurs in a case where a power supply to a liquid crystal display device is turned off while displaying an image. This is because a voltage, applied to each of pixels immediately before the power supply is turned off, remains to be applied to the each of the pixels, i.e., the same image is continuously drawn.

In recent years, a liquid crystal display device has been developed which employs a TFT made of oxide semiconductor that has a characteristic in which an off-leak electric current is extremely small (e.g., indium-gallium-zinc oxide semiconductor). Note, however, that, since this type of liquid crystal display device has a small off-leak electric current, it is difficult to discharge an electric charge which has been accumulated in a pixel, while a power supply to the liquid crystal display device is being turned off. This easily causes the above problems.

In view of the circumstances, a conventional liquid crystal display device is configured such that, when a power supply to the liquid crystal display device is turned off, a given off-sequence is carried out for discharging an electric charge which has been applied to each of pixels of a liquid crystal display panel.

For example, Patent Literature 1 discloses a technique in which an electrolytic capacitor is further provided in a power supply circuit so that, when a power supply to a liquid crystal display device is turned off, processing is carried out in which a given fixed pattern is drawn on an entire screen of a liquid crystal display panel by use of an electric charge which has been accumulated in the electrolytic capacitor. Patent Literature 1 also discloses that drawing of the pattern is carried out in a shorter time than normal, by simultaneously drawing a plurality of lines.

### CITATION LIST

### Patent Literatures

Patent Literature 1

Japanese Patent Application Publication, Tokukai, No. 2000-131671 A (Publication Date: May 12, 2000)

### SUMMARY OF INVENTION

### Technical Problem

According to the technique of Patent Literature 1, however, a special driver needs to be provided for simultaneously driving and drawing a plurality of lines. This causes a problem that a device cost is increased.

The present invention has been made in view of the problems. An object of the present invention is to provide, without greatly increasing a device cost, a liquid crystal display device capable of preventing a voltage from continuing to be applied to a pixel while a power supply is being turned off.

### Solution to Problem

A liquid crystal display device of Embodiment 1 of the present invention includes: control means for carrying out writing processing in which a voltage corresponding to image data is applied to each picture element by (a) periodically selecting a gate bus line, via which writing is carried out and (b) controlling, in accordance with the image data, a voltage to be applied to a source bus line connected to the each picture element connected to a selected gate bus line, in a case where a power supply to the liquid crystal display device is turned off, the control means carrying out power-off processing in which (A) a selection switching cycle of gate bus lines, via each of which writing is carried out, is set shorter than a selection switching cycle during image display and (B) a given voltage for power-off processing is applied to each source bus line.

### Advantageous Effects of Invention

With the configuration, in a case where a given voltage for power-off processing is applied while the power supply is being turned off, it is possible to prevent a voltage from continuing to be applied to a pixel during a period in which the power supply is turned off. In a case where a switching cycle of a gate bus line, via which writing is carried out, is set shorter during power-off processing than during image display, it is possible to shorten a time required for applying the given voltage to each picture element. This allows a reduction in electric power required for power-off processing. Therefore, it is possible to reduce a capacity of electric power supply means which supplies drive electric power for power-off processing, thereby allowing a reduction in cost.

### BRIEF DESCRIPTION OF DRAWINGS

FIG. 1 is an explanatory diagram illustrating a configuration of a liquid crystal display device of Embodiment 1 of the present invention.

FIG. 2 is an explanatory diagram illustrating a configuration of a liquid crystal panel provided in the liquid crystal display device illustrated in FIG. 1.

FIG. 3 is an explanatory diagram illustrating a configuration of a TFT substrate provided in the liquid crystal panel illustrated in FIG. 2.

FIG. 4 is an explanatory diagram illustrating a configuration of a picture element provided in the liquid crystal panel illustrated in FIG. 2.

FIG. 5 is an equivalent circuit diagram of the picture element illustrated in FIG. 4.

FIG. 6 is an explanatory diagram illustrating a configuration of a gate driver provided in the liquid crystal display device illustrated in FIG. 1.

FIG. 7 is an explanatory diagram illustrating a configuration of a source driver provided in the liquid crystal display device illustrated in FIG. 1.

FIG. 8 is an explanatory diagram illustrating a configuration of a gradation electric potential generation circuit provided in the source driver illustrated in FIG. 7.

FIG. 9 is an explanatory diagram illustrating a configuration of an electric current amplification circuit by which the source driver illustrated in FIG. 7 is followed.

FIG. 10 is an explanatory diagram illustrating an example of input data supplied to the source driver illustrated in FIG. 7.

FIG. 11 is an explanatory diagram illustrating timings when pieces of data are written into the respective picture elements of the liquid crystal display device illustrated in FIG. 1.

FIG. 12 is a view illustrating an example of a voltage applied to a gate terminal and a source terminal of a TFT provided in the picture element illustrated in FIG. 4.

FIG. 13 is a graph illustrating characteristics of (i) a TFT provided in the picture element illustrated in FIG. 4 and (ii) a TFT of a Comparative Example.

FIG. 14 is an explanatory diagram illustrating timings when pieces of data are written into picture elements of a liquid crystal display device illustrated in FIG. 1.

FIG. 15 is an explanatory diagram illustrating timings when pieces of data are written into picture elements of a liquid crystal display device of Embodiment 2 of the present invention.

FIG. 16 is an explanatory diagram illustrating timings when pieces of data are written into picture elements of a liquid crystal display device of Embodiment 3 of the present invention.

FIG. 17 is an explanatory diagram illustrating timings when pieces of data are written into picture elements of a liquid crystal display device of Embodiment 4 of the present invention.

FIG. 18 is an explanatory diagram illustrating a configuration of a gate driver provided in a liquid crystal display device of Embodiment 5 of the present invention.

FIG. 19 is an explanatory diagram illustrating a configuration of a liquid crystal display device of Embodiment 6 of the present invention.

### DESCRIPTION OF EMBODIMENTS

### Embodiment 1

The following description will discuss Embodiment 1 of the present invention.

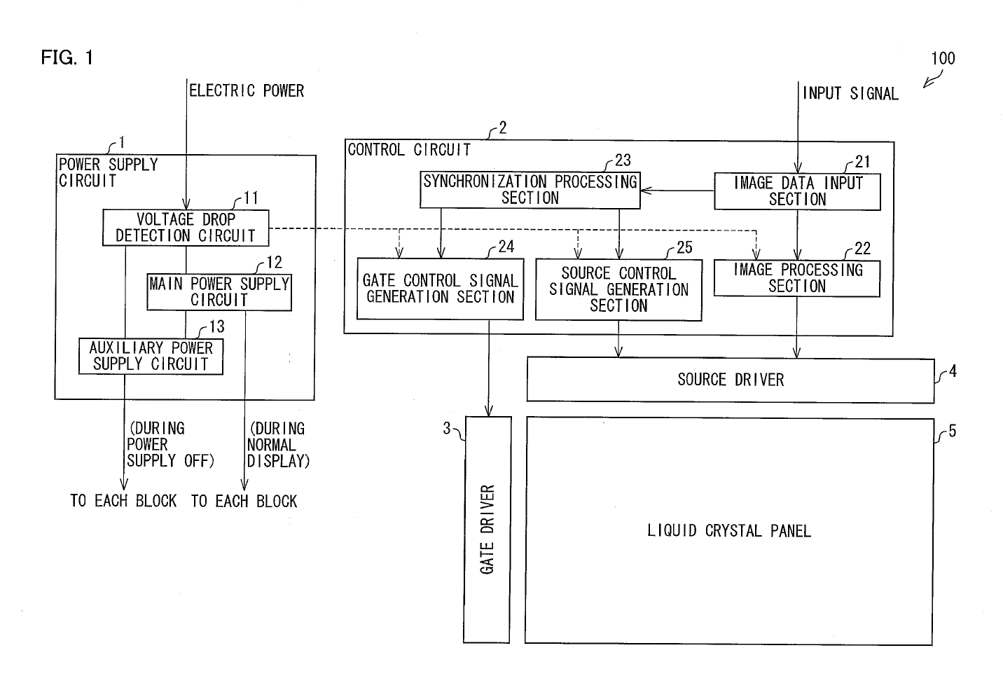

FIG. 1 is an explanatory diagram illustrating a schematic configuration of a liquid crystal display device 100 of Embodiment 1. The liquid crystal display device 100 includes a power supply circuit 1, a control circuit (control means) 2, a gate driver 3, a source driver 4, and a liquid crystal panel 5 (see FIG. 1).

The power supply circuit 1 (i) receives electric power externally supplied (e.g., supplied from a commercial power supply, a private generation power supply, or a charging device) and (ii) supplies electric power to each block (each section) of the liquid crystal display device 100. The power supply circuit 1 includes a voltage drop detection circuit 11, a main power supply circuit 12, and an auxiliary power supply circuit 13.

The voltage drop detection circuit (voltage detection means) 11 monitors an input voltage externally supplied and detects that a power supply to the liquid crystal display device 100 is turned off (e.g., a power supply is turned off by a user's operation, a power supply is turned off due to electric power outage, a disconnection, etc.). According to Embodiment 1, the voltage drop detection circuit 11 monitors the voltage externally supplied. Note, however, that Embodiment 1 is not limited this. For example, the voltage drop detection circuit 11 can be configured to monitor an output voltage supplied from the main power supply circuit 12.

During normal display (i.e., during a period in which the power supply to the liquid crystal display device 100 is being turned on), the main power supply circuit 12 distributes, to each block of the liquid crystal display device 100, electric power externally supplied. Specifically, the main power supply circuit 12 (i) supplies a logic power supply Vlogic to each of an image data input section 21, an image processing section 22, a synchronization processing section 23, a gate control signal generation section 24, and a source control signal generation section 25 and (ii) supplies a logic power supply VL, an analog high-level power supply VGH, and an analog low-level power supply VGL to the gate driver 3. The main power supply circuit 12 further (i) supplies a counter reference electric potential VCOM and a CS reference electric potential (a reference electric potential of a liquid crystal storage capacitor) VCS to the liquid crystal panel 5 and (ii) supplies, to the source driver 4, logic power supplies VCC/LRVDD, an analog power supply VLS, and gradation reference power supplies VL0 through VL1023 and VH0 through VH1023.

The auxiliary power supply circuit 13 includes charging means (not illustrated) such as a capacitor. According to the auxiliary power supply circuit 13, (i) the charging means is charged by externally supplied electric power and (ii), while the power supply to the liquid crystal display device 100 is being turned off, electric power stored by the charging means is supplied to each block which carries out power-off processing of the liquid crystal display device 100. Note that an electric charge which has been accumulated in each picture element of the liquid crystal panel 5 is discharged in the power-off processing, while the power supply to the liquid crystal display device 100 is being turned off. The power-off processing will be discussed later in detail.

Note that the electric power for charging the charging means provided in the auxiliary power supply circuit 13 can be externally supplied directly to the auxiliary power supply circuit 13. Alternatively, such electric power can be supplied from the main power supply circuit 12.

The control circuit 2 generates control signals for displaying, on the liquid crystal panel 5, an image corresponding to an input signal supplied from an outside of the control circuit 2. The control circuit 2 then supplies the control signals thus generated to the gate driver 3 and the source driver 4. The control circuit 2 includes the image data input section 21, the image processing section 22, the synchronization processing section 23, the gate control signal generation section 24, and the source control signal generation section 25. Note that the image data input section 21, the image processing section 22, the synchronization processing section 23, the gate control signal generation section 24, and the source control signal generation section 25 can be constituted by a single chip. Alternatively, these sections can be constituted by a plurality of chips.

The image data input section 21 receives the input signal supplied from the outside of the control circuit 2. The image data input section 21 then supplies an image signal contained in the input signal and a synchronization signal contained in the input signal to the image processing section 22 and the synchronization processing section 23, respectively.

The image processing section 22 converts the image signal supplied from the image data input section 21 into a signal which varies depending on an input format of the source driver 4 and then supplies the signal thus converted to the source driver 4.

The synchronization processing section 23 generates, in accordance with the synchronization signal supplied from the image data input section 21, (i) positional information of each picture element in a horizontal direction and (ii) positional information of the each picture element in a vertical direction. The synchronization processing section 23 then supplies the positional information in the vertical direction and the positional information in the horizontal direction to the gate control signal generation section 24 and the source control signal generation section 25, respectively.

The gate control signal generation section 24 generates, in accordance with the positional information in the vertical direction, which positional information is supplied from the synchronization processing section 23, control signals (e.g., a gate start pulse GSP, a gate clock signal GCK, and a gate output enable GOE) for controlling the gate driver 3. The gate control signal generation section 24 then supplies the control signals thus generated to the gate driver 3.

The source control signal generation section 25 generates, in accordance with the positional information in the horizontal direction, which positional information is supplied from the synchronization processing section 23, control signals (e.g., a latch pulse and a polarity reverse signal for carrying out an AC drive of a liquid crystal) for controlling the source driver 4. The source control signal generation section 25 then supplies the control signals thus generated to the source driver 4.

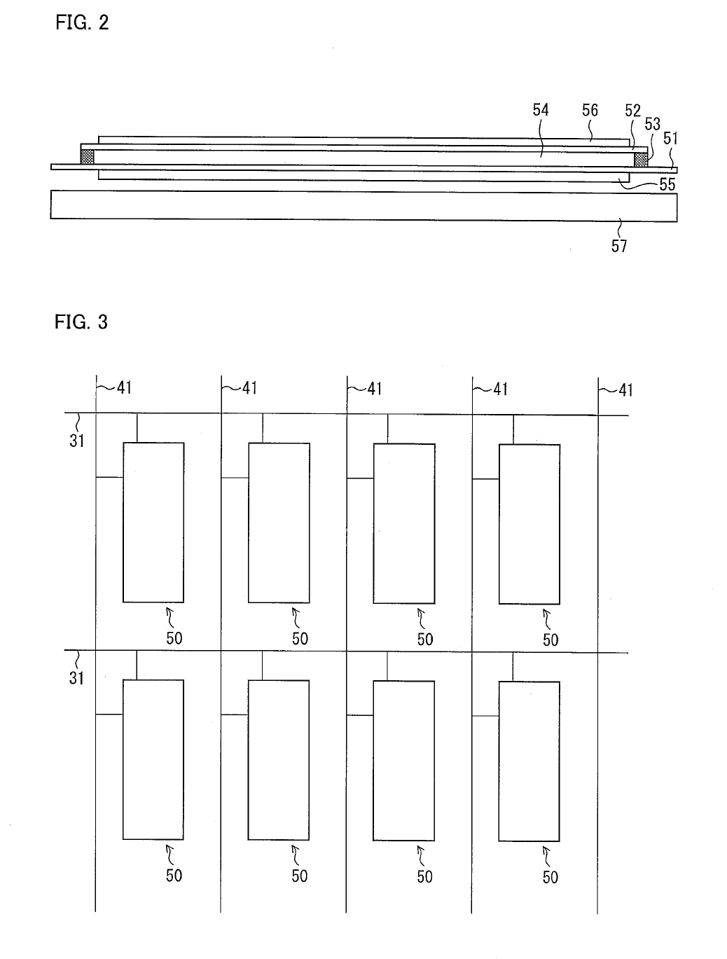

FIG. 2 is an explanatory diagram illustrating a schematic configuration of a liquid crystal panel 5. As illustrated in FIG. 2, the liquid crystal panel 5 includes (i) a TFT substrate 51 and a counter substrate 52 which are provided so as to face each other via a spacer 53, (ii) a liquid crystal layer 54 which is made of liquid crystal material filled between the TFT substrate 51 and the counter substrate 52, (iii) a first polarizing plate 55 provided on a back surface side of the TFT substrate 51 (i.e., a side of a surface opposite to a surface facing the counter substrate 52), (iv) a second polarizing plate 56 provided in a front surface side of the counter substrate 52 (i.e., a side of a surface opposite to a surface facing the TFT substrate 51). A backlight 57 is provided behind the liquid crystal panel 5.

The first polarizing plate 55 transmits, among light emitted from the backlight 57, only light having polarized light corresponding to a polarization axis direction of the first polarizing plate 55. A voltage, corresponding to image data, is applied to the liquid crystal layer 54 of each picture element. This causes birefringence of a liquid crystal corresponding to the each picture element to change in accordance with the image data. Accordingly, a polarization direction of light, passing through the each picture element, changes in accordance with the image data. Moreover, the second polarizing plate 56 transmits, among light which has passed through the liquid crystal layer 54, only light having polarized light corresponding to a polarization axis direction of the second polarizing plate 56. This causes an amount of light transmitted through the liquid crystal panel 5 to be controlled for each picture element and in accordance with the image data, thereby causing an image to be displayed.

One of color filters R (red), G (green), and B (blue) is provided in a region corresponding to each picture element (subpixel) of the counter substrate 52. One pixel is constituted by three picture elements (i.e., R, G, and B) in combination. This causes an amount of light transmitted through each of R, G, and B of a pixel to be controlled for each pixel and in accordance with the image data, thereby causing an image to be displayed. Note that Embodiment 1 has been described on the premise that the picture elements R, G, and B are included. Note, however, that Embodiment 1 is not limited to this. Alternatively, a picture element in other colors can be included.

Embodiment 1 discusses a case where the liquid crystal display device 100 is a transmissive liquid crystal display device 100 which displays an image by use of light emitted from the backlight. However, Embodiment 1 is not limited to this. For example, the liquid crystal display device 100 can be a reflective liquid crystal display device in which externally entered light is reflected and is used as display light. Alternatively, the liquid crystal display device 100 can be a semi-transmissive liquid crystal display device which has both a function of a transmitting-type liquid crystal display device and a function of a reflective liquid crystal display device in combination.

Embodiment 1 discusses the liquid crystal display device which is configured such that the TFT substrate 51 includes the picture element electrode and the counter substrate 52 includes the counter electrode. However, Embodiment 1 is not limited this. Alternatively, the liquid crystal display device can be configured such that the picture element electrode and the counter electrode are both provided on a single substrate.

FIG. 3 is an explanatory diagram illustrating a schematic configuration of a TFT substrate 51. There are provided, on the TFT substrate 51, (i) a large number of gate bus lines 31, (ii) a large number of source bus lines 41, which are provided so as to intersect with the gate bus lines 31 in a grid shape, and (iii) picture elements 50 provided for respective intersections of the gate bus lines 31 and the source bus lines 41 (see FIG. 3).

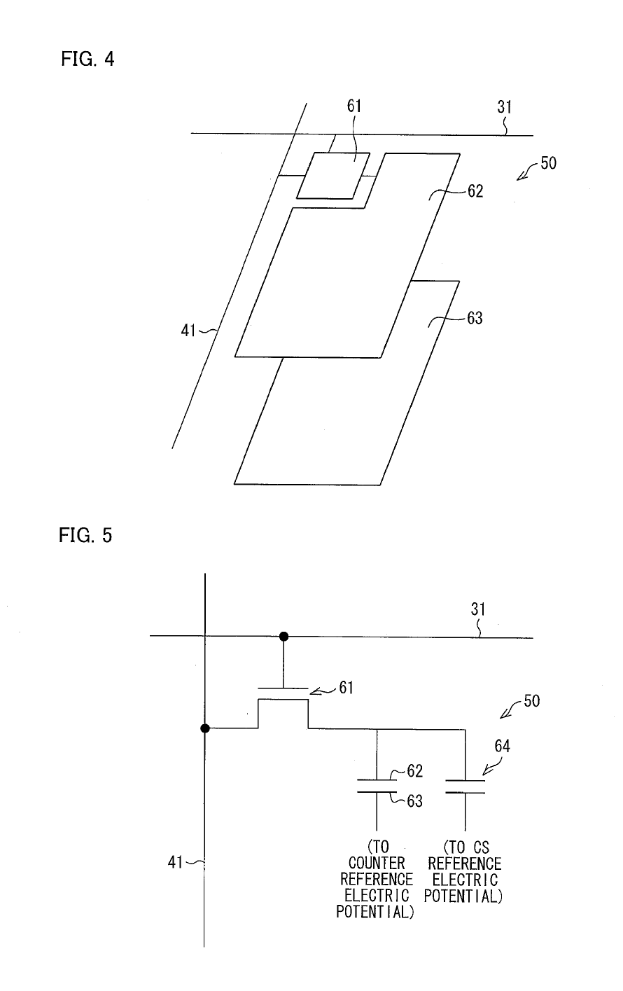

FIG. 4 is an explanatory diagram illustrating a configuration of each of the picture elements 50 provided in the liquid crystal panel 5.

Each of the picture elements 50 includes (i) a TFT (Thin Film Transistor) 61 serving as a switching element, (ii) a picture element electrode 62, and (iii) a counter electrode 63 (see FIG. 4). The TFT 61 has a gate terminal, a source terminal, and a drain terminal which are connected to the gate bus line 31, the source bus line 41, and the picture element electrode 62, respectively.

Note that Embodiment 1 employs a TFT, which serves as a TFT 61, including a channel layer made of indium-gallium-zinc oxide semiconductor (oxide semiconductor). Note, however, that a configuration of the TFT 61 is not limited to this. Alternatively, it is possible to employ a TFT including (i) a channel layer which is made of oxide semiconductor other than indium-gallium-zinc oxide semiconductor or (ii) a channel layer which is made of a material other than oxide semiconductor.

The gate bus lines 31 are each connected to a gate driver 3, and the source bus lines 41 are each connected to a source driver 4. A reference electric potential (i.e., counter electric potential) is applied to the counter electrode 63, via a counter wire (not illustrated) provided on the counter substrate 52.

As such, the gate driver 3 periodically selects a gate bus line 31, via which writing is carried out. And, in synchronization with the gate driver 3, the source driver 4 controls, in accordance with the image data, a voltage applied to a source bus line connected to a picture element connected to a selected gate bus line. This causes an orientation direction of each of the liquid crystal molecules to be controlled in accordance with a voltage, corresponding to the image data, to be applied to the liquid crystal layer 54 of the picture element 50, thereby causing an image to be displayed.

FIG. 5 is an equivalent circuit diagram of a picture element 50. In a case where a voltage of a gate terminal of the TFT 61 is higher than that of a source terminal of the TFT 61 by a given value or more, the TFT 61 is turned on. An electric current flows through the source terminal and the drain terminal, accordingly. This causes an electric potential of a source bus line 41 to be applied to a liquid crystal capacitor (a liquid crystal layer 54). According to the equivalent circuit diagram, the picture element electrode 62, the counter electrode 63, and the liquid crystal layer 54 are illustrated as a capacitor. Note that the example illustrated in FIG. 5 includes a liquid crystal storage capacitor (CS capacitor) 64 which (i) is arranged in parallel to a liquid crystal capacitor (defined by the picture element electrode 62, the liquid crystal layer 54, and the counter electrode 63) and (ii) is provided for maintaining an electric potential of the picture element. Note, however, that the liquid crystal storage capacitor 64 is not an essential component and can therefore be omitted.

The gate driver 3 periodically selects a gate bus line 31, via which writing is carried out, by controlling, in accordance with the control signal supplied from the gate control signal generation section 24, a voltage to be applied to each of gate bus lines 31 provided on the liquid crystal panel 5.

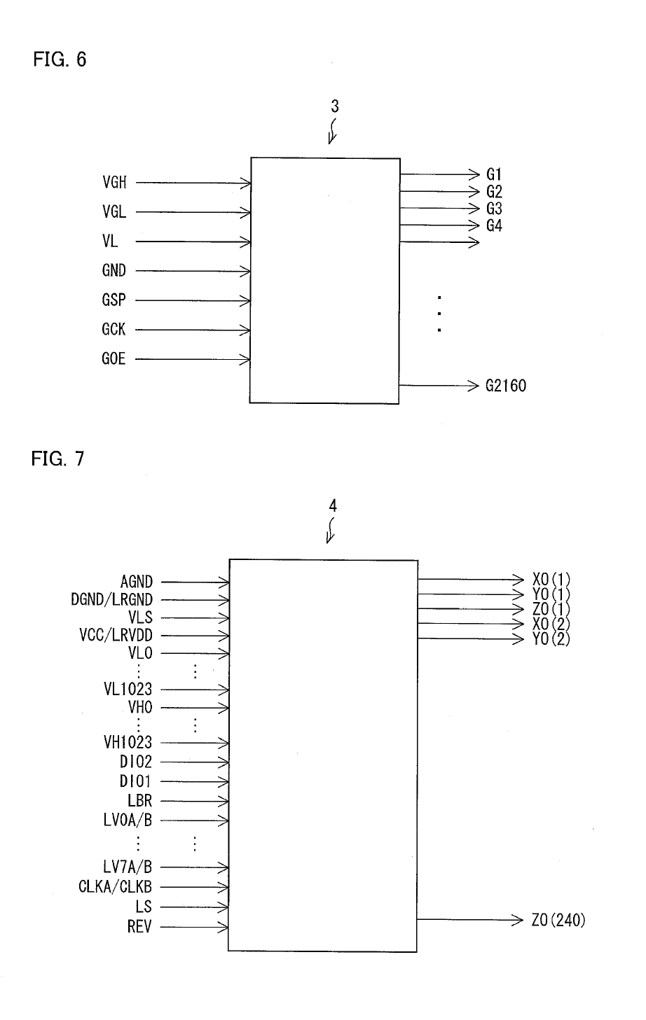

FIG. 6 is an explanatory diagram illustrating a configuration of the gate driver 3. A high-level power supply VGH to be applied to a gate bus line 31, a low-level power supply VGL to be applied to a gate bus line 31, a logic power supply VL, and a ground electric potential (reference electric potential) GND for logic circuits are each supplied to the gate driver 3 (see FIG. 6). Note that these signals are each supplied from the power supply circuit 1 (or another power supply circuit of the liquid crystal display device 100). A gate start pulse GSP, a gate clock signal GCK, and a gate enable signal GOE are each supplied from the gate control signal generation section 24 to the gate driver 3. G1, G2, . . . , G2160 are connected to a first gate bus line 31, a second gate bus line 31, . . . , a 2160th gate bus line 31 of the liquid crystal panel 5, respectively.

In accordance with the control signal supplied from the source control signal generation section 25, the source driver 4 controls voltages to be applied to the respective source bus lines 41, in synchronization with a timing when the gate driver 3 selects a gate bus line 31 via which writing is carried out. Specifically, in accordance with a signal supplied from the image processing section 22 and a polarity reverse signal supplied from the source control signal generation section 25, the source driver 4 generates electric potentials to be applied to the respective source bus lines 41 (i.e., electric potentials to be applied to picture elements connected to the gate bus lines 31 via which writing is carried out, among the picture elements connected to the respective source bus lines 41). The source driver 4 then applies the electric potentials thus generated to the respective source bus lines 41, in synchronization with a timing of a latch pulse LS supplied from the source control signal generation section 25.

FIG. 7 is an explanatory diagram illustrating a configuration of the source driver 4. Note that Embodiment 1 employs a normally black liquid crystal panel 5 in which picture elements are displayed in black in a case where no electric potential is applied to the picture elements. Note, however, that Embodiment 1 is not limited to this. Alternatively, a normally white liquid crystal panel 5 can be employed.

As illustrated in FIG. 7, the following (i) through (xii) are supplied to the source driver 4 (i) a ground electric potential AGND of analog power supply, (ii) an analog power supply VLS, (iii) ground electric potentials DGND/LRGND for logic circuits, (iv) logic power supplies VCC/LRVDD, (v) gradation reference power supplies VL0, . . . , VL1023, each of which is used in a case where a polarity is negative, (vi) gradation reference power supplies VH0, . . . , VH1023, each of which is used in a case where a polarity is positive, (vii) cascade signals DIO2 and DIO1, each of which is used in a case where a plurality of source drivers 4 are employed, (viii) a switching signal LBR for switching an order of data corresponding to an input signal, (ix) picture element data LV0A/B, . . . , LV7A/B, (x) clock signals CLKA/CLKB, (xi) a latch pulse LS which controls a timing for switching output data, and (xii) a polarity reverse signal REV for reversing a polarity of a voltage to be applied to the source bus line 41.

XO (1), YO (1), ZO (1), XO (2), YO (2), ZO (2), . . . , are connected to respective source bus lines 41 and drive picture elements connected to the respective source bus lines 41. Note that X, Y, and Z indicate one of three primary colors R, G, and B.

Liquid crystal molecules are polar molecules. Accordingly, in a case where an electric field is continuously applied, in an identical direction, to liquid crystal molecules for a long time, the liquid crystal molecules are polarized. This causes image sticking and/or deviation in characteristic to occur. In view of the circumstances, according to Embodiment 1, an AC drive (i.e., a polarity reversal drive) is carried out in which an electric potential applied to each picture element electrode 62 is alternately switched between (i) an electric potential (positive) which is higher than that of a counter electric potential and (ii) an electric potential (negative) which is lower than that of the counter electric potential. The polarity reverse signal REV is a signal for carrying out the switching of the electric potential applied to each picture element electrode 62. In a case where the polarity reverse signal REV is in high level (H), a polarity of a voltage applied to each of XO(1), YO(1), ZO(1), XO(2), YO(2), ZO(2), . . . is +, −, +, −, +, −, . . . . Meanwhile, in a case where the polarity reverse signal REV is in low level (L), the polarity of the voltage applied to each of XO(1), YO(1), ZO(1), XO(2), YO(2), ZO(2), . . . is switched to −, +, −, +, −, +, . . . .

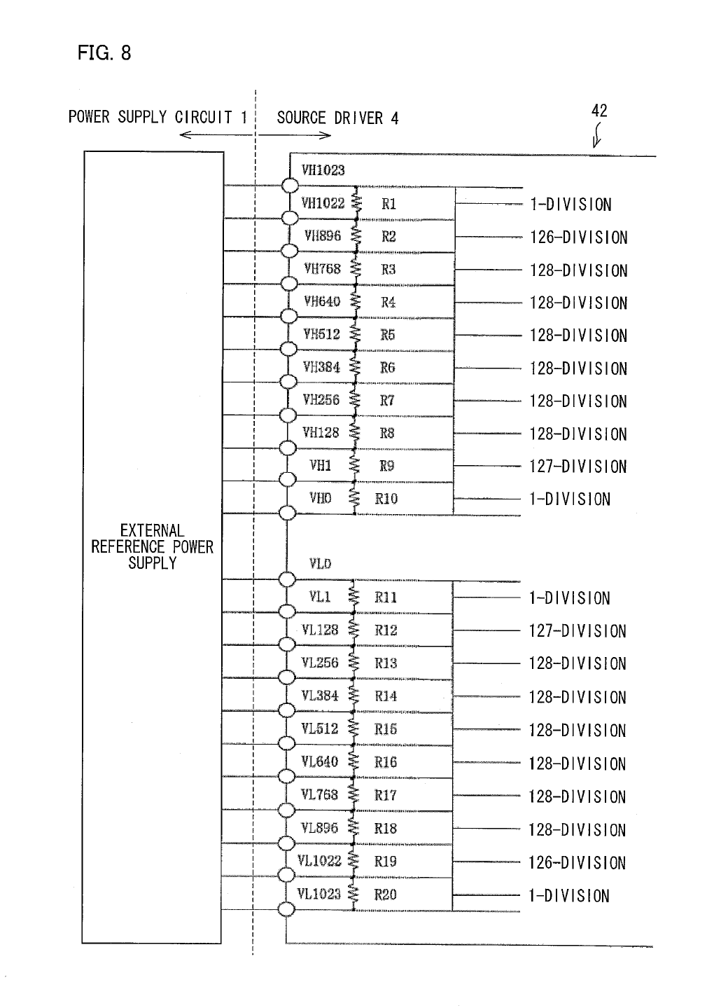

FIG. 8 is an explanatory diagram illustrating a circuit configuration of a gradation electric potential generation circuit 42 provided in the source driver 4. As has been described, transmittance of each of the picture elements of the liquid crystal panel 5 is adjusted by controlling a voltage to be applied to the picture element electrode of the each of the picture elements so as to carry out gradation display. Note that, according to Embodiment 1, voltages to be applied to any adjacent picture elements are caused to have respective reverse polarities and the AC drive is carried out in which a polarity of a voltage to be applied to each picture element is reversed for each frame. For this reason, in order to carry out the AC drive, the following two electric potentials are prepared for each gradation value, that is, (i) an electric potential to be used in a case where an applied voltage has a positive polarity and (ii) an electric potential to be used in a case where an applied voltage has a negative polarity. For example, in a case where gradation display of 328 gradations is carried out, two electric potentials VH328 and VL328 are prepared. The gradation display of 328 gradations can be carried out by applying a voltage of VH328 to the picture element electrode in a case where an applied voltage has a positive polarity, whereas by applying a voltage of VL328 to the picture element electrode in a case where an applied voltage has a negative polarity.

According to Embodiment 1, the gradation electric potential generation circuit 42 (see FIG. 8) generates a voltage to be applied from the source driver 4 to the source bus line 41. Specifically, Embodiment 1 employs a 10-bit source driver 4, and the generation circuit generates 2048 types of electric potentials in total, that is, 1024 types of electric potentials VH0 thorough VH1023 for positive polarity and 1024 types of electric potentials VL0 through VL1023 for negative polarity. Note that in a case where no electric potential is supplied from an external reference power supply, a reference electric potential is set by resistances R1 through R20 of a dryer. Note, however, that, in a case where a reference electric potential which meets a relationship between an applied voltage and a transmittance of the liquid crystal panel 5 differs from the reference electric potential set by the resistances, the voltage can be adjusted by supplying an electric potential from the external reference power supply. Such an external reference power supply can be included, for example, in the power supply circuit 1.

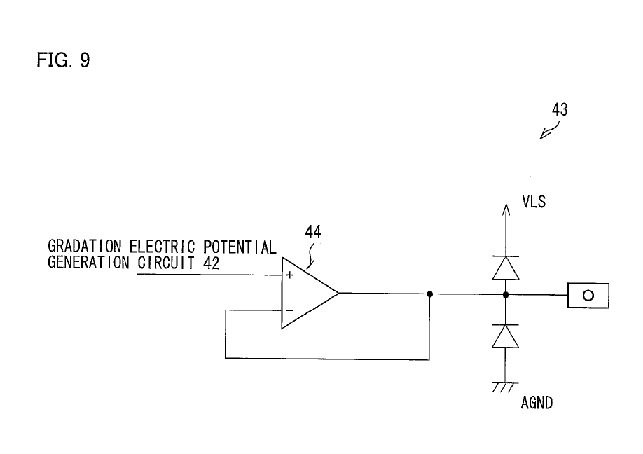

FIG. 9 is an explanatory diagram illustrating a configuration of an electric current amplification circuit 43 by which the source driver 4 is followed. An electric potential of a reference power supply, which has been generated by the gradation electric potential generation circuit 42 (see FIG. 8), is supplied to the electric current amplification circuit 43. An operational amplifier 44 amplifies an electric current and supplies the electric current thus amplified to the source bus line 41.

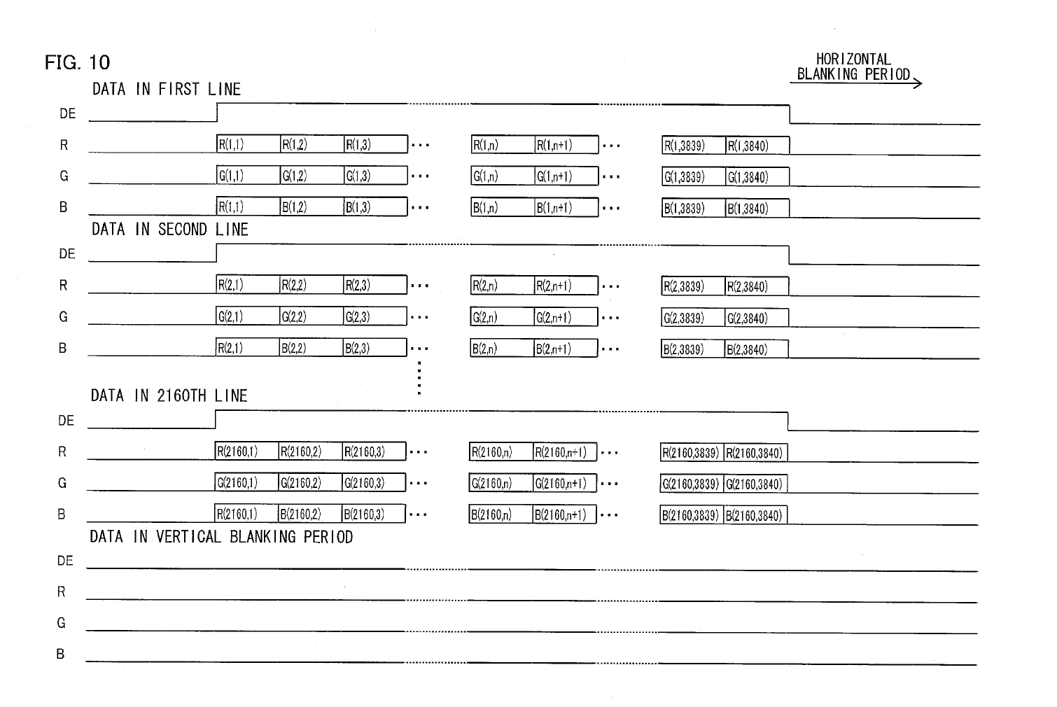

FIG. 10 is an explanatory diagram illustrating an example of input data supplied to the source driver 4. As illustrated in FIG. 10, a pixel located in an upper left of a screen is assumed to be expressed by (1, 1), and gradation signals in respective three colors R, G, and B are transmitted from left to right in a first line. After the transmittance of data in the first line is finished, data in a second line is transmitted. A horizontal blanking period is secured between respective adjacent lines. As to a vertical direction, a vertical blanking period is secured from completion of inputting of data for one (1) screen until data for a next screen is inputted. A data enable signal DE is an example of a synchronization signal indicative of a position of data. A data enable signal DE of high level indicates that data exists, whereas a data enable signal DE of low level indicates that no data exists.

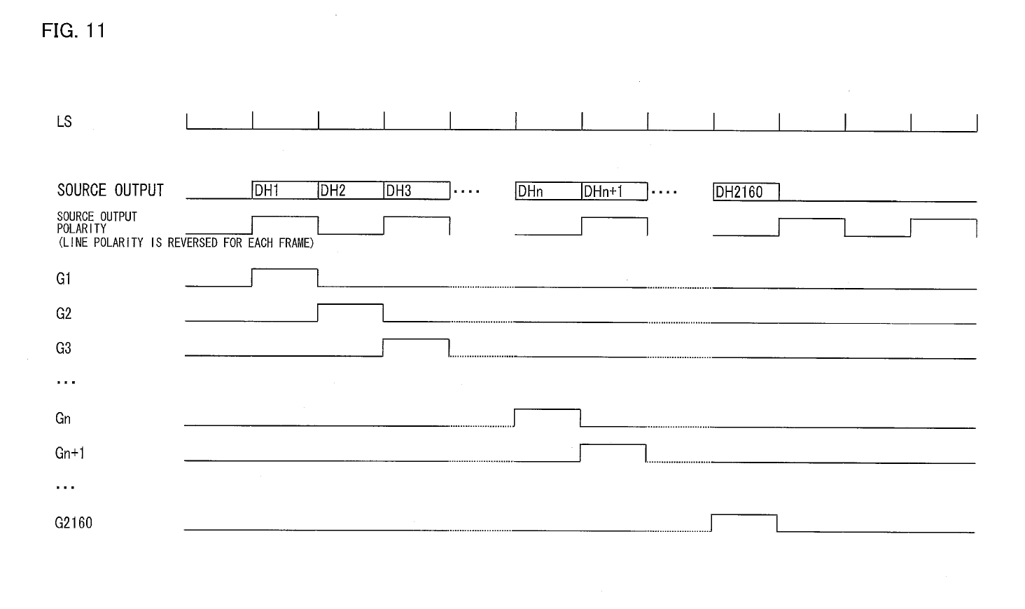

FIG. 11 is an explanatory diagram illustrating timings when pieces of data are written into the respective picture elements, that is, timings when voltages are applied to the gate bus lines 31 and the source bus lines 41. As illustrated in FIG. 11, DH1, DH2, . . . , DH2160 indicate respective pieces of output data which are supplied from the source driver 4 to respective lines from a first line to a 2160th line. G1, G2, . . . , G2160 indicate output signals supplied from gate driver 3 to respective gate bus lines 31.

Each time a latch pulse LS becomes high level, the source driver 4 simultaneously switches electric potentials to be written into the respective source bus lines 41. That is, the source driver 4 writes data corresponding to one (1) line (i.e., one (1) gate bus line) each time the latch pulse LS becomes high level.

The gate driver 3 supplies, one by one in sequence, an electric potential of high level to the gate bus lines 31, in synchronization with a timing of the latch pulse LS.

In a case where an electric potential of a gate bus line 31 becomes high level, electric potentials of gate terminals of TFTs 61 of respective picture elements which are connected to the gate bus line 31, become high level. This causes an electric current to flow through from a source terminal to a drain terminal of each of the TFTs 61 so that electric potentials of source bus lines 41 connected to the respective TFTs 61 are applied to respective picture element electrodes 62. By carrying out this operation sequentially for all gate bus lines 31, display for one (1) screen is carried out. Note that an operation in which an electric potential is applied to a picture element electrode of each picture element in this way is referred to as “writing”. As with Embodiment 1, writing carried out for each line is referred to as “line sequence”.

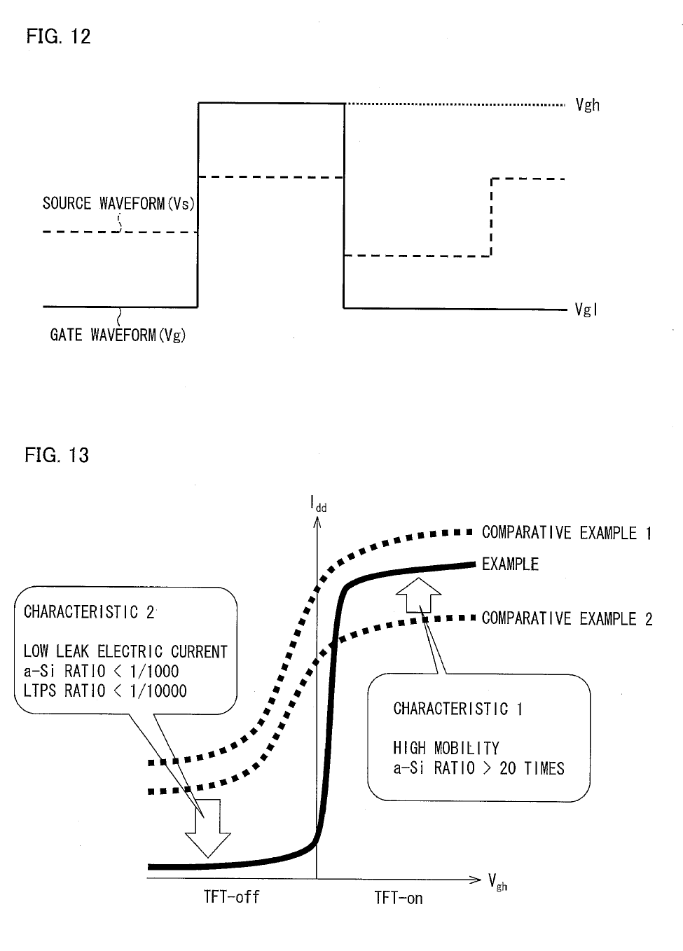

FIG. 12 is a view illustrating an example of a voltage applied to a gate terminal and a source terminal of a TFT 61. While the voltage applied to the gate terminal is high level (Vgh), the source terminal and the drain terminal are electrically connected. This causes a voltage applied to a source terminal via a source bus line 41 to be applied to a picture element electrode 62.

Note that, as has been described, Embodiment 1 employs a TFT, which serves as a TFT 61, including a channel layer made of indium-gallium-zinc oxide semiconductor.

FIG. 13 is a graph in which characteristics are compared among a TFT made of indium-gallium-zinc oxide semiconductor (Example), a TFT made of low-temperature polysilicon (LTPS) (Comparative Example 1), and a TFT made of amorphous silicon (a-Si) (Comparative Example 2). Note that, in the graph of FIG. 13, (i) a horizontal axis indicates an electric potential difference between a gate and a source (Vg-Vs) and (ii) vertical axis indicates an electric current flowing through the source and a drain.

As is clear from FIG. 13, the TFT made of indium-gallium-zinc oxide semiconductor has a characteristic in which an off-leak electric current (i.e., an electric current flowing through the source and the drain while the TFT is being turned off) is (i) 1/1000 or less of an off-leak electric current of the TFT made of amorphous silicon (a-Si) and (ii) 1/10000 or less of an off-leak electric current of the TFT made of low-temperature polysilicon (LPTS).

The TFT, made of indium-gallium-zinc oxide semiconductor, has the characteristic in which an off-leak electric current is small. Such a characteristic improves a characteristic which is obtained during driving (e.g., reduction in electric power consumption) but causes a problem that it is difficult to discharge an electric charge which has been charged in a picture element electrode when a power supply to a liquid crystal display device is turned off. In a case where the electric charge remains in the picture element electrode, an electric potential difference between the picture element electrode and a counter electrode causes an electric field to continue to be applied, in a certain direction, to a liquid crystal layer. This causes polarization of liquid crystal molecules made of polar molecules, thereby causing a problem such as deviation in characteristic and image sticking.

For this reason, the liquid crystal display device 100 of Embodiment 1 carries out a given power-off processing for discharging, while the power supply is being turned off, an electric charge by which a picture element electrode has been charged.

(1-2. Power-Off Processing)

Next, the following description will discuss power-off processing which is carried out with respect to the liquid crystal panel 5 while the power supply to the liquid crystal display device 100 is being turned off.

As described above, in a case where a voltage is continuously applied to each picture element for a long time while the power supply is being turned off, a problem such as image sticking may occur.

In order to address such a problem, Embodiment 1 is configured so that the voltage drop detection circuit 11 monitors an input voltage supplied to the power supply circuit 1 (or an output voltage supplied from the power supply circuit 1) and detects that the power supply to the liquid crystal display device 100 is turned off. In a case where the voltage drop detection circuit 11 detects that the power supply to the liquid crystal display device 100 is turned off, power-off processing is carried out in which a given electric potential for power-off processing is written into each picture element. Note that the liquid crystal display device 100 can be configured so that the power-off processing is started in a case where a power supply button of the liquid crystal display device 100 is operated or in a case where an instruction to turn off the power supply is entered via a remote control.

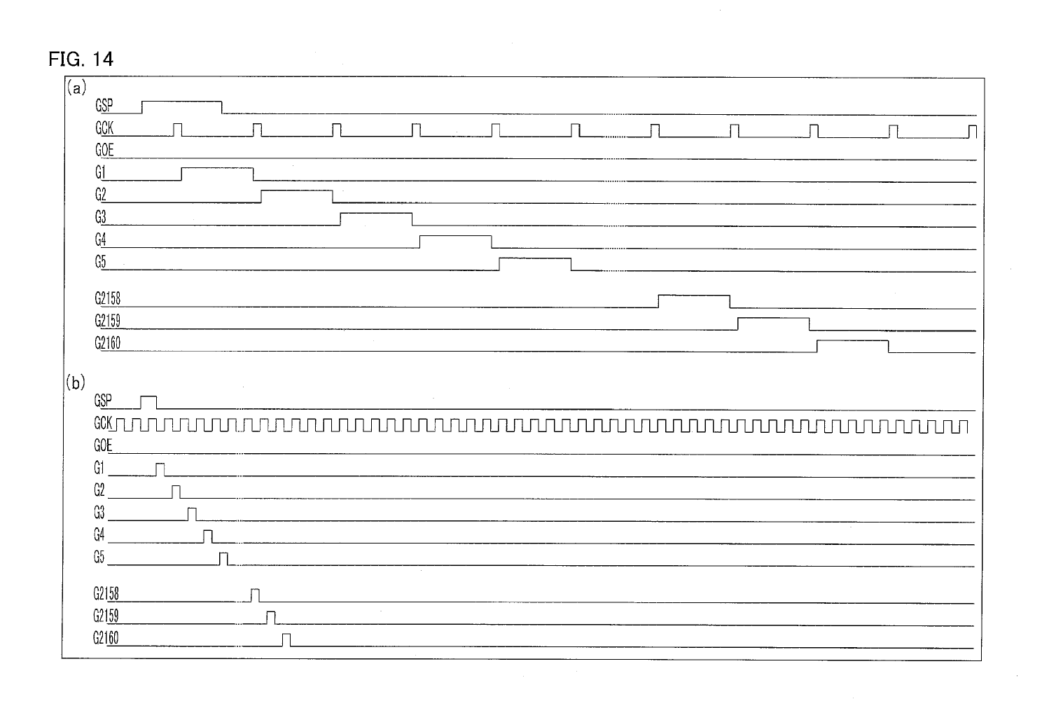

FIG. 14 is an explanatory diagram illustrating an example of a control signal of the liquid crystal panel 5 of the liquid crystal display device 100. (a) of FIG. 14 illustrates a control signal which is used during normal display. (b) of FIG. 14 illustrates a control signal which is used during power-off processing.

According to Embodiment 1, while a gate start pulse GSP is in high level, in synchronization with a timing when a gate clock signal GCK switches from high level to low level, an electric potential of a gate bus line 31 to be selected is switched to high level (see FIG. 14). Thereafter, when the gate clock signal GCK switches from low level to high level, the electric potential of the gate bus line 31 is switched to low level. That is, a voltage of high level is applied to one (1) gate bus line 31 during a period between a falling edge of the gate clock signal GCK (i.e., changing from low level to high level) and next rising edge of the gate clock signal GCK (i.e., changing from high level to low level).

Thereafter, in a case where the gate clock signal GCK again switches from high level to low level, an electric potential of a next gate bus line 31 is switched to high level. Then, in a case where the gate clock signal GCK switches from low level to high level, the electric potential of the gate bus line 31 is switched to low level. This processing is repeated until selections of all the gate bus lines are completed.

Note that, according to Embodiment 1, a period during which the gate clock signal GCK is in high level serves as a non-writing period during which no gate bus line 31 is selected (i.e., no voltage of high level is applied to any gate bus lines 31). This makes it possible to prevent an image from being improperly displayed due to a delay, occurred in the gate bus line 31, in transmission of an applied voltage. That is, in a case where the gate bus line 31 is long in length, such a delay, occurred in the gate bus line 31, in transmission of an applied voltage causes a deviation of (i) a timing when the TFT 61 is turned on at a part distant from the gate driver 3 from a timing when the TFT 61 is turned on at a part near the gate driver 3. This may cause a timing, when the TFT 61 is turned on, to deviate from a timing when the source driver 4 switches voltages applied to the respective source bus lines 41, thereby preventing an image from being properly displayed. In contrast, with the present configuration, a non-writing period, in which no high-level voltage is applied to any gate bus line 31, is secured each time a gate bus line 31 to which a high-level voltage is to be applied is switched. It is therefore possible to prevent an image from being improperly displayed due to a deviation of (i) a timing when a voltage is applied to the source bus line 41 from (ii) a timing when the gate bus line 31 is driven.

The gate enable signal GOE is a signal which causes all outputs from the gate driver 3 to be stopped in a case where the gate enable signal GOE is in high level (i.e., a signal which causes all the gate bus lines 31 to be low level). According to Embodiment 1, the gate enable signal GOE is fixed to low level. Note that, although the polarity reverse signal REV is not illustrated in FIG. 14, Embodiment 1 is configured so that a polarity of an electric potential to be applied to each of the source bus lines 41 is reversed for each line (i.e., for each gate bus line 31).

According to Embodiment 1, a cycle of the gate clock signal GCK during normal display (i.e., a selection switching cycle on which a low level and a high level of the gate clock signal GCK are switched and a gate bus line 31, via which writing is carried out, is selected) is set so that selections of all the gate bus lines 31 are completed within one (1) frame period (see (a) of FIG. 14).

According to Embodiment 1, a cycle of the gate clock signal GCK is set shorter during power-off processing than during normal display (see (b) of FIG. 14).

Specifically, the voltage drop detection circuit 11 monitors an input voltage supplied to the power supply circuit 1 (or an output voltage supplied from the power supply circuit 1). In a case where a detection voltage of the voltage drop detection circuit 11 becomes a given voltage or less, the voltage drop detection circuit 11 transmits, to each of the auxiliary power supply circuit 13, the image processing section 22, the gate control signal generation section 24, and the source control signal generation section 25, a signal (a power-off signal) for causing power-off processing to be started.

The auxiliary power supply circuit 13 supplies, to each of the image processing section 22, the gate control signal generation section 24, and the source control signal generation section 25, electric power which has been charged by the charging means included in the auxiliary power supply circuit 13.

Upon receipt of a power-off signal from the voltage drop detection circuit 11, the image processing section 22 supplies, to the source driver 4, data for power-off processing (i.e., data for causing a given voltage for power-off processing to be written into each picture element). According to Embodiment 1, a polarity of a voltage to be applied to each picture element is reversed for each frame. The image processing section 22 supplies, to the source driver 4, data for causing a voltage, which has a positive polarity and corresponds to a black image (i.e., a voltage corresponding to a gradation value 0), to be applied to each picture element during power-off processing.

Specifically, according to Embodiment 1, a voltage to be applied to the gate bus line 31 is set so that the high-level power supply VGH is equal to 36V and the low-level power supply VGL is equal to −6V. In a case where a voltage of a positive polarity is applied to the source bus line 41, the voltage to be applied to the source bus line 41 is set, in accordance with a gradation of image data, to fall within a range of 8.0V (=VH0) to 15.6V (=VH1023). In a case where a voltage of a negative polarity is applied to the source bus line 41, the voltage to be applied to the source bus line 41 is set, in accordance with a gradation of image data, to fall within a range of 8.0V (=VL0) to 0.2V (=VL1023). The source driver 4 applies 8.0V (=VH0), which serves as a voltage for power-off processing, to the source bus lines 41.

In order to cause the TFT 61 to function as a switching element, even in a case where an electric potential of the source terminal is maximum (VH1023), it is necessary to switch the TFT 61 from off to on. For this reason, according to Embodiment 1, (VGH−VH1023) is set to be equal to 20.4V. Moreover, even in a case where an electric potential of the source terminal is minimum (VL1023), it is necessary to switch the TFT 61 from on to off. For this reason, according to Embodiment 1, (VGL−VL1023) is set to be equal to −6.2V. In order to satisfy all of the above conditions, according to Embodiment 1, (VGH−VGL) is set to be equal to 42V. A process withstand voltage of the gate driver 3 is also set so as to withstand this electric potential difference.

Note that a range of an electric potential, to be applied to a source bus line 41, which fluctuates in accordance with a gradation is (i) 7.4V (=(VH1023−VH0)) in a case where a voltage to be applied to the source bus line 41 has a positive polarity and (ii) 7.4V (=(VL0−VL1023)) in a case where a voltage to be applied to the source bus line 41 has a negative polarity.

As describe above, a fluctuation range of the voltage to be applied to the source bus line 41 with respect to a fluctuation range of the voltage to be applied to the gate bus line 31 is comparatively small. As is clear from the characteristics of the TFTs illustrated in FIG. 13, a leak electric current which flows from the drain terminal to the source terminal of the TFT 61 varies depending on a voltage to be applied to the picture element electrode 62.

According to Embodiment 1, the TFT 61 of NPN junction is employed. A leak electric current flowing from the drain terminal to the source terminal varies depending on a potential difference between the gate terminal and the drain terminal. A larger leak electric current flows, as the drain terminal has a lower electric potential. Accordingly, in a case where an electric potential to be written into each picture element during power-off processing is set low, the leak electric current flowing from the drain terminal to the source terminal can be increased. This facilitates discharging an electric charge of the picture element electrode to the source bus line 41 during a period in which the power supply to the liquid crystal display device 100 is turned off.

Note that, according to Embodiment 1, a voltage to be applied to each picture element during power-off processing is set to a voltage corresponding to the gradation value 0. However, Embodiment 1 is not limited to this, provided that the voltage to be applied to each picture element is set to such a voltage that does not make apparent a problem such as image sticking (i.e., such a voltage that a deterioration in display characteristic is not visible to a user) even in a case where the voltage continues to be applied to the each picture element. For example, the voltage to be applied to each picture element can be set to a voltage lower than a voltage corresponding to the gradation value 0. Alternatively, the voltage to be applied to each picture element can be set to a voltage slightly larger than a voltage corresponding to the gradation value 0. In general, in a case where a voltage to be applied to each picture element during power-off processing is set to a voltage within a range of [(V1−V2)×0.1+V2] to zero (0), it is possible to prevent a problem such as image sticking from being apparent even in a case where the voltage remains to be accumulated in the each picture element during a period in which the power supply is turned off. In [(V1−V2)×0.1+V2″], V 1 indicates a maximum voltage to be applied to each picture element in a case where a voltage to be applied to each picture element has a positive polarity, V2 indicates a minimum voltage to be applied to each picture element in a case where a voltage to be applied to each of picture element has a positive polarity. Note that voltages to be applied to respective picture elements during power-off processing can be identical to each other. Alternatively, the voltage to be applied can vary from picture element to picture element.

Upon receipt of a power-off signal from the voltage drop detection circuit 11, the source control signal generation section 25 generates a control signal for causing a voltage to be applied to each source bus line 41 in accordance with the data supplied from the image processing section 22. The source control signal generation section 25 then supplies the control signal thus generated to the source driver 4.

Upon receipt of a power-off signal from the voltage drop detection circuit 11, the gate control signal generation section 24 supplies, to the gate driver 3, a signal for causing a cycle of the gate clock signal GCK to be set shorter than that during normal display (see (b) of FIG. 14). That is, according to the conventional liquid crystal display device which carries out writing processing in which an electric potential for power-off processing is written into each picture element during power-off processing, a selection switching cycle of a gate bus line is consistent irrespective of whether it is during normal display or during power-off processing. In contrast, according to Embodiment 1, a selection switching cycle of the gate bus line 31 during power-off processing is switched to a cycle shorter than that during normal display.

Note that, according to Embodiment 1, a cycle of the gate clock signal GCK during power-off processing is set so that a cycle on which the TFT 61 of each picture element is turned on is 7.7 μs or more. Note, however, that the cycle of the gate clock signal GCK during power-off is not limited to this, provided that it is set so that the cycle of the gate clock signal GCK is shorter than that during normal display and so that a cycle in which the TFT 61 of each picture element is turned on (i.e., a period in which the source terminal and the drain terminal are electrically connected) is a time period during which an applied voltage for power-off processing can be written into a picture element electrode of the each picture element, thereby preventing a problem such as image sticking. Specifically, the cycle of the gate clock signal GCK during power-off processing is set preferably so that the period during which the TFT 61 of each picture element is turned on is 3.5 μs or more, more preferably 4.0 μs or more, and still more preferably 7.7 μs or more.

As has been described above, the liquid crystal display device 100 of the Embodiment 1 includes (i) the voltage drop detection circuit 11 which detects that the power supply to the liquid crystal display device 100 is turned off and (ii) the control circuit 2 (the image processing section 22, the gate control signal generation section 24, and source control signal generation section 25) which carries out power-off processing in which a voltage for power-off processing is supplied to each picture element 50 of the liquid crystal panel 5 when the voltage drop detection circuit 11 detects that the power supply to the liquid crystal display device 100 is turned off. The control circuit 2 sets a selection switching cycle of the gate bus lines 31 during power-off processing shorter than that during image display.

With the configuration, it is possible to shorten a time required for power-off processing, that is, a time required for writing a voltage for power-off processing into each picture element 50. This allows a reduction in drive electric power required for power-off processing. Therefore, it is possible to reduce a capacity of charging means (i.e., charging means such as a capacitor included in the auxiliary power supply circuit 13) for charging drive electric power used while the power supply is being turned off, thereby allowing a reduction in cost.

### Embodiment 2

The following description will discuss Embodiment 2 of the present invention. For convenience, members which have functions identical with those illustrated in the drawings of Embodiment 1 are given identical reference numerals, and are not described repeatedly.

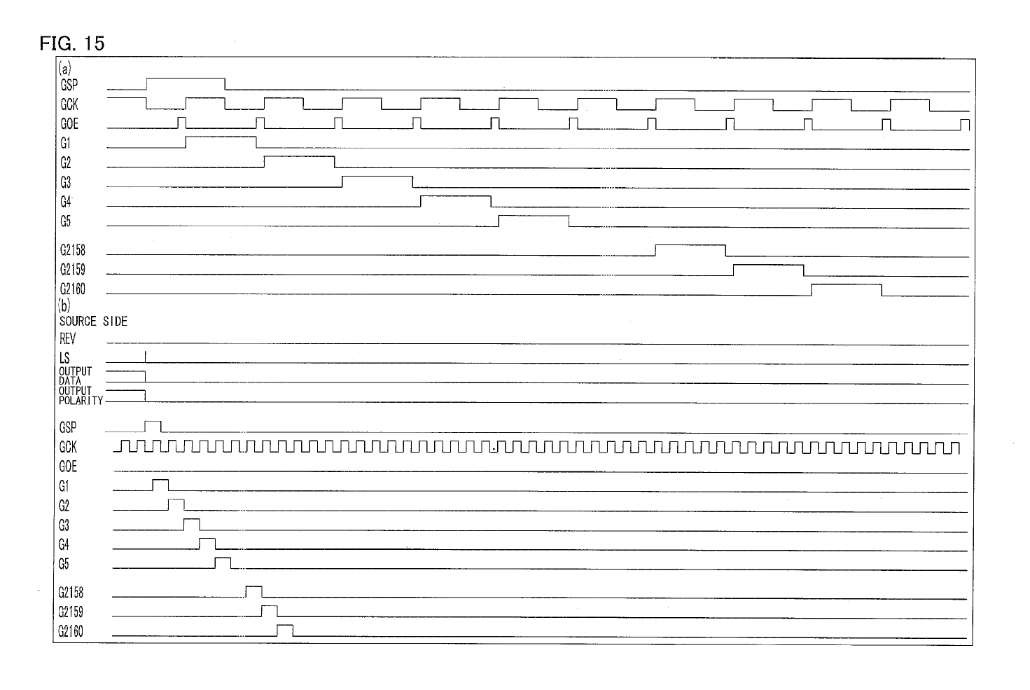

FIG. 15 is an explanatory diagram illustrating an example of a control signal of the liquid crystal panel 5 of the liquid crystal display device 100 of Embodiment 2. (a) of FIG. 15 illustrates a control signal which is used during normal display. (b) of FIG. 15 illustrates a control signal which is used during power-off processing.

As illustrated in (a) of FIG. 15, during normal display, an electric potential of a gate bus line 31 to be selected is switched to high level in synchronization with a timing when a gate clock signal GCK switches from low level to high level after a gate start pulse GSP becomes high level. A gate enable signal GOE switches from low level to high level, during a given period immediately before the gate clock signal GCK switches from low level to high level. The gate enable signal GOE is a signal which causes all outputs from the gate driver 3 to be stopped in a case where the gate enable signal GOE is in high level (i.e., a signal which causes all the gate bus lines 31 to be low level). Thereafter, in a case where the gate clock signal GCK switches from low level to high level, an electric potential of a next gate bus line 31 is switched to high level. This processing is repeated until selections of all the gate bus lines are completed.

Meanwhile, during power-off processing, the gate enable signal GOE is fixed to low level (see (b) of FIG. 15). An electric potential of a gate bus line 31 to be selected is switched to high level in synchronization with a timing when a gate clock signal GCK switches from low level to high level after a gate start pulse GSP becomes high level. Thereafter, in a case where the gate clock signal GCK switches from high level to low level and then switches from low level to high level, an electric potential of the gate bus line 31 which has been selected until then is switched to low level and an electric potential of a next gate bus line 31 is switched to high level. This processing is repeated until selections of all the gate bus lines are completed.

According to Embodiment 2, as with Embodiment 1, a cycle of the gate clock signal GCK is set shorter during power-off processing than during normal display. According to Embodiment 2, during power-off processing, a polarity reverse signal REV is fixed to low level.

With the liquid crystal display device 100 of Embodiment 2, as with Embodiment 1, it is possible to shorten a time required for power-off processing. This allows a reduction in drive electric power required for power-off processing. Therefore, it is possible to reduce a capacity of charging means for charging drive electric power used while the power supply is being turned off, thereby allowing a reduction in cost.

During normal display, a period is secured in which when a gate bus line 31 to be selected is switched, the gate enable signal GOE is in high level. As such, each time a gate bus line 31 is switched, a period in which all the gate bus lines 31 become low level (i.e., a non-writing period) is secured. This makes it possible to prevent an image from being improperly displayed due to a delay, occurred in the gate bus line 31, in transmission of an applied voltage.

In a case where the gate enable signal GOE is fixed to low level during power-off processing, no non-writing period is secured during which all the gate bus lines 31 become low level. Note, however, the non-writing period is secured during normal display. This makes it possible to set a time period, during which a voltage for power-off processing is written into each picture element, longer than that in a case where a non-writing period is secured. This allows a voltage, to be actually written into each picture element, to get closer to the voltage for power-off processing.

Note that, according to Embodiment 2, the polarity reverse signal REV is fixed to low level during power-off processing. It follows that electric potentials for power-off processing which have identical polarities are applied to all the source bus lines. Therefore, during power-off processing, a voltage to be applied to the source bus line 41 is not switched. This prevents, even in a case where no non-writing period is secured during power-off processing, an image from being improperly displayed due to a delay, occurred in the gate bus line 31, in transmission of an applied voltage.

### Embodiment 3

The following description will discuss Embodiment 3 of the present invention. For convenience, members which have functions identical with those illustrated in the drawings of Embodiments 1 and 2 are given identical reference numerals, and are not described repeatedly.

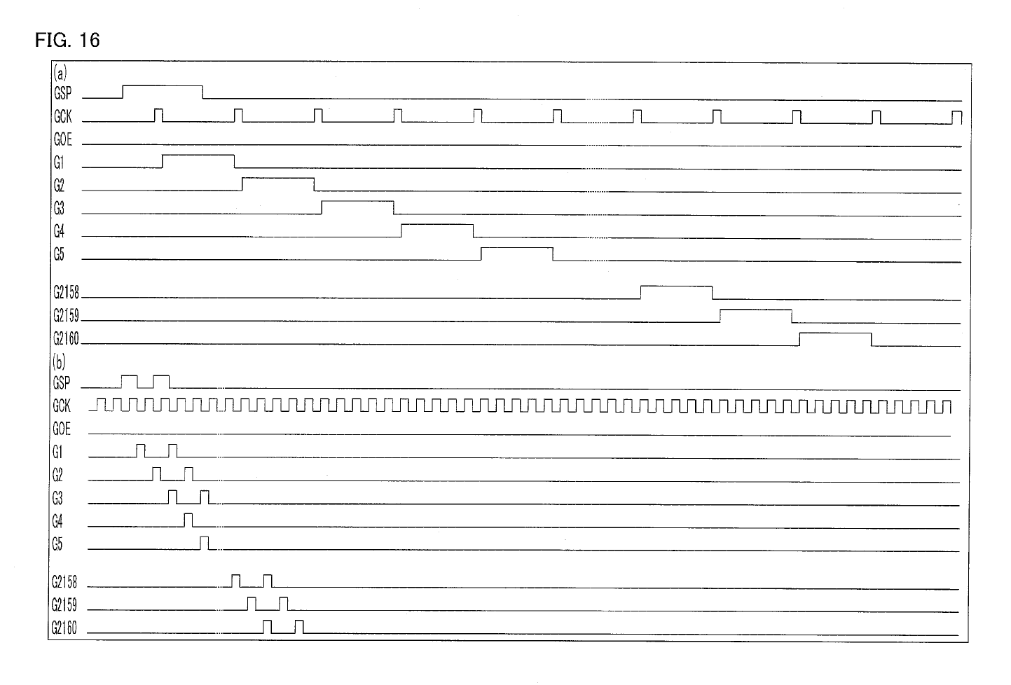

FIG. 16 is an explanatory diagram illustrating an example of a control signal of the liquid crystal panel 5 of the liquid crystal display device 100 of Embodiment 3. (a) of FIG. 16 illustrates a control signal which is used during normal display. (b) of FIG. 16 illustrates a control signal which is used during power-off processing.

As illustrated in (a) of FIG. 16, an operation carried out during normal display is identical to that described in Embodiment 1 (see (a) of FIG. 14).

As illustrated in (b) of FIG. 16, a cycle of a gate clock signal GCK is set shorter during power-off processing than during normal display. A gate start pulse GSP is switched to high level a plurality of times (twice in the example illustrated in (b) of FIG. 16) during a period in which voltages, corresponding to one (1) screen, for power-off processing are written. Accordingly, writing is carried out into one (1) gate bus line a plurality of times during a period in which voltages, corresponding to one (1) screen, for power-off processing are written into one (1) gate bus line.

With the liquid crystal display device 100 of Embodiment 3, as with Embodiments 1 and 2, it is possible to shorten a time required for power-off processing. This allows a reduction in drive electric power required for power-off processing. Therefore, it is possible to reduce a capacity of charging means for charging drive electric power used while the power supply is being turned off, thereby allowing a reduction in cost.

In a case where the voltage for power-off processing is written into each gate bus line a plurality of times, it is possible to lengthen a total time period during which the voltage for power-off processing is written into the each gate bus line. This allows a voltage to be actually written into each picture element to get closer to the voltage for power-off processing.

According to the example illustrated in (b) of FIG. 16, it is set so that a period during which the gate start pulse GSP is in high level occurs every other clock (i.e., one (1) gate clock signal GCK). In this case, writing is carried out in an odd-numbered plurality of gate bus lines in a single period, whereas writing is carried out in an even-numbered plurality of gate bus lines in another single period.

According to Embodiment 3, voltages to be written into a plurality of gate bus lines in a single period are therefore identical in polarity, regardless of a polarity reverse signal REV. For this reason, according to Embodiment 3, the polarity reverse signal REV can be fixed to low level or high level during power-off processing. Alternatively, the polarity reverse signal REV can be reversed for each of the gate bus lines as with during normal display.

Note that Embodiment 3 is not limited to the configuration in which the period, during which the gate start pulse GSP is in high level, is set to occur every other clock. Alternatively, the gate start pulse GSP can be inputted in synchronization with successive clocks (i.e., a period during which the gate clock signal GCK is in high level). Note, however, that, in this case, since writing is carried out into a plurality of gate bus lines adjacent to each other in a single period, it is preferable to fix the polarity reverse signal REV to high level or low level.

### Embodiment 4

The following description will discuss Embodiment 4 of the present invention. For convenience, members which have functions identical with those illustrated in the drawings of Embodiments 1 through 3 are given identical reference numerals, and are not described repeatedly.

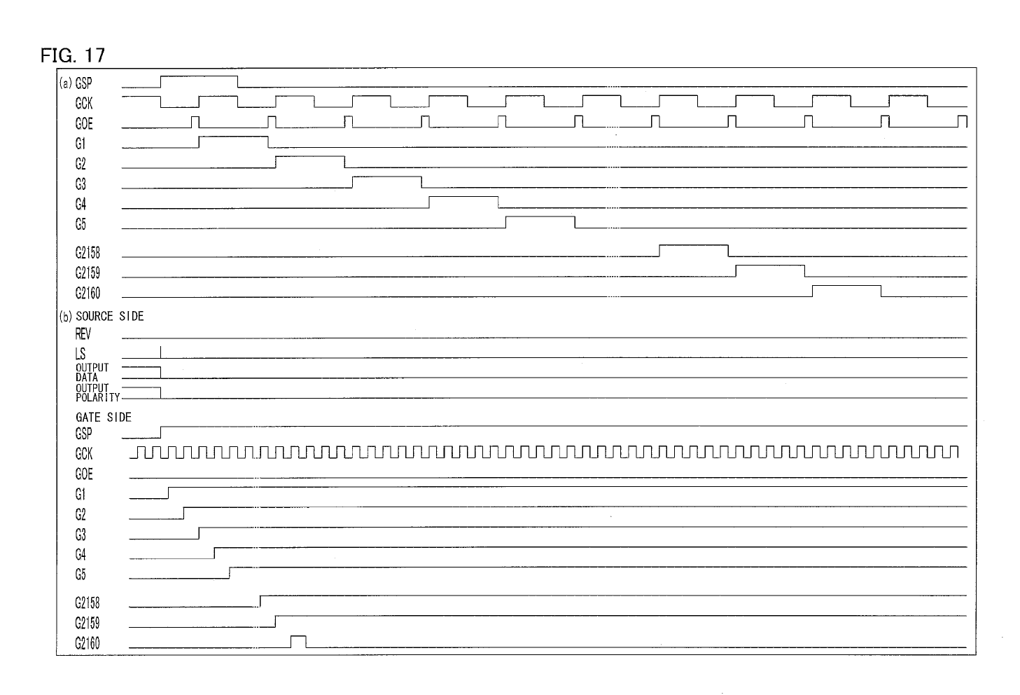

FIG. 17 is an explanatory diagram illustrating an example of a control signal of the liquid crystal panel 5 of the liquid crystal display device 100 of Embodiment 4. (a) of FIG. 17 illustrates a control signal which is used during normal display. (b) of FIG. 17 illustrates a control signal which is used during power-off processing.

As illustrated in (a) of FIG. 17, an operation carried out during normal display is identical to that described in Embodiment 2 (see (a) of FIG. 15).

During power-off processing, as illustrated in (b) of FIG. 17, a gate start pulse GSP and a gate enable signal GOE are fixed to high level and to low level, respectively. Moreover, a polarity reverse signal REV is maintained at low level, and a cycle of a gate clock signal GCK is set shorter than that during normal display.

As such, after it is detected that a power supply is turned off and the gate start pulse GSP becomes high level, at a timing when the gate clock signal GCK switches from low level to high level, electric potentials of respective gate bus lines 31 are sequentially switched to high level. The electric potentials of the respective gate bus lines 31 which have been switched to high level are maintained at high level, regardless of a subsequent gate start pulse GSP.

With the liquid crystal display device 100 of Embodiment 4, as with the Embodiments 1 through 3 above, it is possible to shorten a time required for power-off processing. This allows a reduction in drive electric power required for power-off processing. Therefore, it is possible to reduce a capacity of charging means for charging drive electric power used while the power supply is being turned off, thereby allowing a reduction in cost.

The gate bus lines 31 are sequentially switched to high level. Once a gate bus line 31 is switched to high level, such a gate bus line 31 is maintained at high level after that. Accordingly, it is possible to lengthen a time period during which an electric potential for power-off processing is written into each picture element. This allows a voltage, to be actually written into each picture element, to get closer to the voltage for power-off processing.

### Embodiment 5

The following description will discuss Embodiment 5 of the present invention. For convenience, members which have functions identical with those illustrated in the drawings of the Embodiments 1 through 4 above are given identical reference numerals, and are not described repeatedly.

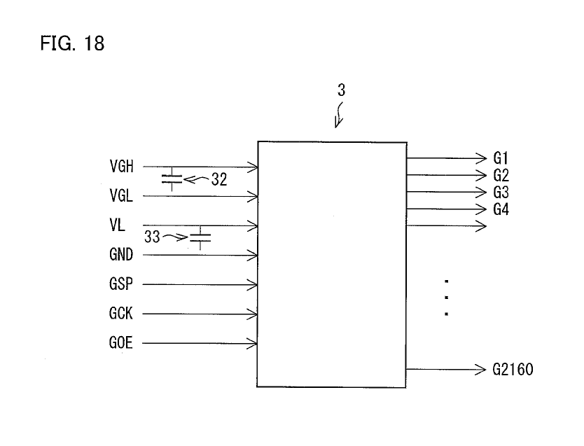

FIG. 18 is an explanatory diagram illustrating a configuration of a gate driver 3 provided in a liquid crystal display device 100 of Embodiment 5. The gate driver 3 is configured as with the gate driver 3 of Embodiment 1 (see FIG. 6). However, capacitors (charging sections) 32 and 33 are connected to power supply input lines of each of a logic power supply VL and an analog high-level power supply VGH, respectively.

Note that operations carried out by the liquid crystal display device 100 of Embodiment 5 during normal display and during power-off processing are similar to those described in Embodiment 4.

With the liquid crystal display device 100 of Embodiment 5, since the capacitors 32 and 33 are connected to the power supply input lines of each of the logic power supply VL and the analog high-level power supply VGH, respectively, it is possible to charge the capacitors 32 and 33 during power-on. It is therefore possible to maintain the gate bus lines 31 at high level by using, during power-off processing, the electric power which has been charged by the capacitors 32 and 33. Accordingly, it is possible to lengthen a time period during which a voltage for power-off processing is written into each picture element by maintaining the voltages applied to respective gate bus lines 31 at high level. This allows a voltage to be actually written into each picture element to get closer to the voltage for power-off processing.

Note that it is also possible to employ a gate driver 3 in which logic output is maintained even in a case where no electric power is supplied. In that case, no capacitor 33 needs to be provided.

### Embodiment 6

The following description will discuss Embodiment 6 of the present invention. For convenience, members which have functions identical with those illustrated in the drawings of the Embodiments 1 through 5 above are given identical reference numerals, and are not described repeatedly.

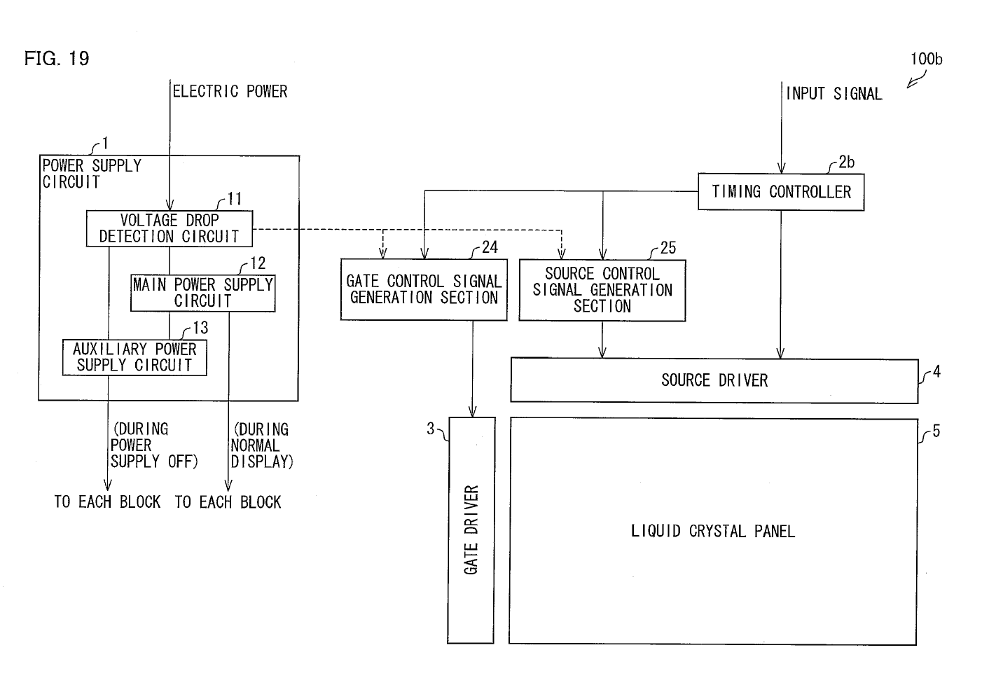

FIG. 19 is an explanatory diagram illustrating a configuration of a liquid crystal display device 100b of Embodiment 6. The liquid crystal display device 100b differs from the liquid crystal display device 100 illustrated in FIG. 1 in that (i) a timing controller 2b is provided instead of the image data input section 21, the image processing section 22, and the synchronization processing section 23 and (ii) a gate control signal generation section (control means) 24 and a source control signal generation section (control means) 25 are further provided. It is possible to employ, as a timing controller 2b, for example, a timing controller IC which has conventionally employed for various purposes.

According to an example illustrated in FIG. 19, a control signal for controlling the gate driver 3 is supplied from the timing controller 2b to the gate control signal generation section 24. Meanwhile, a control signal for controlling the source driver 4 is supplied from the timing controller 2b to the source control signal generation section 25.

During normal display, the gate control signal generation section 24 and the source control signal generation section 25 supply the control signals supplied from the timing controller 2b as they are, to the gate driver 3 and the source driver 4, respectively.

During power-off processing, the gate control signal generation section 24 generates a control signal for causing the power-off processing, described in one of Embodiments 1 through 5, to be carried out. The gate control signal generation section 24 then supplies the control signal thus generated to the gate driver 3. During power-off processing, the source control signal generation section 25 generates a control signal for causing the power-off processing, described in one of Embodiments 1 through 5, to be carried out. The source control signal generation section 25 then supplies the control signal thus generated to the source driver 4.

[Software Implementation Example]

Control blocks of the liquid crystal display device 100 (particularly, the control circuit 2, the gate control signal generation section 24, the source control signal generation section 25, and the image processing section 22) may be realized by a logic circuit (hardware) provided in an integrated circuit (IC chip) or the like or may be realized by software as executed by a CPU (Central Processing Unit).

In the latter case, the liquid crystal display device 100 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### SUMMARY

A liquid crystal display device of Embodiment 1 of the present invention includes: control means for carrying out writing processing in which a voltage corresponding to image data is applied to each picture element by (a) periodically selecting a gate bus line, via which writing is carried out and (b) controlling, in accordance with the image data, a voltage to be applied to a source bus line connected to the each picture element connected to a selected gate bus line, in a case where a power supply to the liquid crystal display device is turned off, the control means carrying out power-off processing in which (A) a selection switching cycle of gate bus lines, via each of which writing is carried out, is set shorter than a selection switching cycle during image display and (B) a given voltage for power-off processing is applied to each source bus line.

With the configuration, in a case where a given voltage for power-off processing is applied while the power supply is being turned off, it is possible to prevent a voltage from continuing to be applied to a pixel during a period in which the power supply is turned off. In a case where a switching cycle of a gate bus line, via which writing is carried out, is set shorter during power-off processing than during image display, it is possible to shorten a time required for applying the given voltage to each picture element. This allows a reduction in electric power required for power-off processing. Therefore, it is possible to reduce a capacity of electric power supply means which supplies drive electric power for power-off processing, thereby allowing a reduction in cost.

According to the liquid crystal display device of Embodiment 1, a liquid crystal display device of Embodiment 2 of the present invention is configured such that: the picture element includes a picture element electrode, a counter electrode, a liquid crystal layer provided between the picture element electrode and the counter electrode, and a switching element in which a gate terminal, a source terminal, and a drain terminal are connected to a gate bus line, a source bus line, and the picture element electrode, respectively; and the switching element is a thin film transistor including a channel layer made of oxide semiconductor.

A thin film transistor including a channel layer made of oxide semiconductor has a characteristic in which an off-leak electric current is extremely small. Accordingly, in a case where, while the power supply to the liquid crystal display device is being turned off, there remains a potential difference between the picture element electrode and the counter electrode, the potential difference is continuously applied during a period in which the power supply is turned off. This easily causes a problem such as image sticking. In contrast, with the present configuration, the potential difference between the picture element electrode and the counter electrode can be reduced by the power-off processing. Accordingly, even in a case where a thin film transistor including a channel layer made of oxide semiconductor is employed, it is possible to prevent a problem such as image sticking from occurring due to the potential difference between the picture element electrode and the counter electrode.

According to the liquid crystal display device of Embodiment 1 or 2, a liquid crystal display device of Embodiment 3 of the present invention is configured such that: the control means causes a polarity of a voltage to be applied to each picture element to be reversed for each frame or every two or more frames during image display; and the given voltage is set within a range of [(V1−V2)×0.1+V2] to zero (0), where V1 indicates a maximum voltage to be applied to each picture element in a case where a voltage to be applied to each picture element has a positive polarity, and V2 indicates a minimum voltage to be applied to each picture element in a case where a voltage to be applied to each of picture element has a positive polarity.

With the configuration, in a case where a given voltage is applied to each picture element during power-off processing, it is possible to reduce a voltage to be applied to the each picture element during a period in which the power supply to the liquid crystal display device is tuned off. This can prevent a deterioration in display characteristic.

According to the liquid crystal display device of one of Embodiments 1 through 3, a liquid crystal display device of Embodiment 4 of the present invention is configured such that: the control means (a) has, during image display, a non-writing period during which no gate bus line is selected as a gate bus line, via which writing is carried out, each time a gate bus line, via which writing is carried out, is selected and (b) has no non-writing period during power-off processing.

With the configuration, in a case where a non-writing period is secured during normal display, it is possible to prevent an image from being improperly displayed due to a delay, occurred in the gate bus line, in transmission of a signal. In a case where no non-writing period is secured during power-off processing, it is possible to shorten a time required for applying the given voltage for power-off processing to each picture element.

According to the liquid crystal display device of one of Embodiments 1 through 4, a liquid crystal display device of Embodiment 5 of the present invention is configured such that: during power-off processing, the control means selects, in a single period, a plurality of gate bus lines, via each of which writing is carried out.

With the configuration, in a case where during power-off processing, a plurality of gate bus lines, via each of which writing is carried out, are selected in a single period, it is possible to shorten a time required for applying the given voltage for power-off processing to each picture element.

According to the liquid crystal display device of one of Embodiments 1 through 5, a liquid crystal display device of Embodiment 6 of the present invention is configured such that: during power-off processing, the control means (a) sequentially selects gate bus lines, via each of which writing is carried out and (b) continuously maintains selected gate bus lines as gate bus lines via each of which writing is carried out, even after a gate bus line, via which writing is carried out, is subsequently selected.

With the configuration, it is possible to lengthen a time period during which a voltage is written into each picture element. This allows a voltage to be actually applied to each picture element to get closer to the given voltage for power-off processing.

According to the liquid crystal display device of Embodiment 6, a liquid crystal display device of Embodiment 7 of the present invention further includes: a charging section which is charged when a power supply to the liquid crystal display device is in an on state, the charging section supplying, during power-off processing, electric power charged by the charging section as electric power for continuously maintaining a selected gate bus line as a gate bus line, via which writing is carried out.

With the configuration, during power-off processing, by use of the electric power charged by the charging section, it is possible to continuously maintain a selected gate bus line as a gate bus line, via which writing is carried out.

According to the liquid crystal display device of Embodiment 1, a liquid crystal display device of Embodiment 8 of the present invention further includes: voltage detection means which detects a reduction in a power supply voltage of the liquid crystal display device, the control means carrying out the power-off processing in a case where the voltage detection means detects that the power supply voltage becomes a given voltage or less.

With the configuration, it is possible to detect, by the voltage detection means, that the power supply to the liquid crystal display device is turned off. This allows the power-off processing to be automatically carried out.

According to the liquid crystal display device of one of Embodiments 1 through 8, a liquid crystal display device of Embodiment 9 of the present invention is configured such that: during image display, the control means causes polarities of voltages, to be applied to source bus lines connected to respective picture elements which are connected to a corresponding one of the gate bus lines, to be reversed for the each gate bus line; and during power-off processing, the control means causes a polarity of a voltage to be applied to each source bus line to be consistent regardless of a gate bus line, via which writing is carried out.

With the configuration, in a case where a polarity of a voltage to be applied to each picture element is caused to be consistent during power-off processing, it is possible to easily control a voltage to be applied to each source bus line during power-off processing.

A method of controlling a liquid crystal display device for carrying out writing processing in which a voltage corresponding to image data is applied to each picture element by (a) periodically selecting a gate bus line, via which writing is carried out and (b) controlling, in accordance with the image data, a voltage to be applied to a source bus line connected to the each picture element connected to a selected gate bus line, the method including the step of: in a case where a power supply to the liquid crystal display device is turned off, carrying out power-off processing in which (A) a selection switching cycle of gate bus lines, via each of which writing is carried out, is set shorter than a selection switching cycle during image display and (B) a given voltage for power-off processing is applied to each source bus line.

With the method, in a case where a given voltage for power-off processing is applied while the power supply is being turned off, it is possible to prevent a voltage from continuing to be applied to a pixel during a period in which the power supply is turned off. In a case where a switching cycle of a gate bus line, via which writing is carried out, is set shorter during power-off processing than during image display, it is possible to shorten a time required for applying the given voltage to each picture element. This allows a reduction in electric power required for power-off processing. Therefore, it is possible to reduce a capacity of electric power supply means which supplies drive electric power for power-off processing, thereby allowing a reduction in cost.

The control means for the liquid crystal display device according to the foregoing embodiments of the present invention may be realized by a computer. In this case, the present invention encompasses: a control program for the liquid crystal display device which program causes a computer to operate as the control means so that the control means can be realized by the computer; and a computer-readable storage medium storing the control program therein.

The present invention is not limited to the description of the embodiments above, but may be altered by a skilled person in the art within the scope of the claims. That is, an embodiment based on a proper combination of technical means altered within the scope of the claims is encompassed in the technical scope of the present invention.

### INDUSTRIAL APPLICABILITY

The present invention is applicable to a liquid crystal display device. The present invention is particularly applicable to a liquid crystal display device which employs, as a switching element, for example, a thin film transistor made of oxide semiconductor which has a small off-leak electric current.

### REFERENCE SIGNS LIST

1: Power supply circuit
2: Control circuit (control means)
2b: Timing controller
3: Gate driver
4: Source driver
5: Liquid crystal panel
11: Voltage drop detection circuit (voltage detection means)
12: Main power supply circuit
13: Auxiliary power supply circuit
21: Image data input section
22: Image processing section (control means)
23: Synchronization processing section (control means)
24: Gate control signal generation section (control means)
25: Source control signal generation section (control means)
31: Gate bus line
32, 33: Capacitor (charging section)
41: Source bus line
42: Gradation electric potential generation circuit
43: Electric current amplification circuit
44: Operational amplifier
50: Picture element
51: TFT substrate
52: Counter substrate
53: Spacer
54: Liquid crystal layer
55: First polarizing plate
56: Second polarizing plate
57: Backlight
61: TFT
62: Picture element electrode
63: Counter electrode
64: Liquid crystal storage capacitor
100: Liquid crystal display device
100b: Liquid crystal display device

1. A liquid crystal display device, comprising:
control means for carrying out writing processing in which a voltage corresponding to image data is applied to each picture element by (a) periodically selecting a gate bus line, via which writing is carried out and (b) controlling, in accordance with the image data, a voltage to be applied to a source bus line connected to the each picture element connected to a selected gate bus line,
in a case where a power supply to said liquid crystal display device is turned off, the control means carrying out power-off processing in which (A) a selection switching cycle of gate bus lines, via each of which writing is carried out, is set shorter than a selection switching cycle during image display and (B) a given voltage for power-off processing is applied to each source bus line.

2. The liquid crystal display device as set forth in claim 1, wherein:
the picture element includes a picture element electrode, a counter electrode, a liquid crystal layer provided between the picture element electrode and the counter electrode, and a switching element in which a gate terminal, a source terminal, and a drain terminal are connected to a gate bus line, a source bus line, and the picture element electrode, respectively; and
the switching element is a thin film transistor including a channel layer made of oxide semiconductor.

3. The liquid crystal display device as set forth in claim 1, wherein:
the control means causes a polarity of a voltage to be applied to each picture element to be reversed for each frame or every two or more frames during image display; and
the given voltage is set within a range of [(V1−V2)×0.1+V2] to zero (0), where V1 indicates a maximum voltage to be applied to each picture element in a case where a voltage to be applied to each picture element has a positive polarity, and V2 indicates a minimum voltage to be applied to each picture element in a case where a voltage to be applied to each of picture element has a positive polarity.

4. The liquid crystal display device as set forth in claim 1, wherein the control means (a) has, during image display, a non-writing period during which no gate bus line is selected as a gate bus line, via which writing is carried out, each time a gate bus line, via which writing is carried out, is selected and (b) has no non-writing period during power-off processing.

5. The liquid crystal display device as set forth in claim 1, wherein, during power-off processing, the control means selects, in a single period, a plurality of gate bus lines, via each of which writing is carried out.

6. The liquid crystal display device as set forth in claim 1, wherein
during power-off processing, the control means (a) sequentially selects gate bus lines, via each of which writing is carried out and (b) continuously maintains selected gate bus lines as gate bus lines via each of which writing is carried out, even after a gate bus line, via which writing is carried out, is subsequently selected.

7. The liquid crystal display device as set forth in claim 6, further comprising:
a charging section which is charged when a power supply to said liquid crystal display device is in an on state,
the charging section supplying, during power-off processing, electric power charged by the charging section as electric power for continuously maintaining a selected gate bus line as a gate bus line, via which writing is carried out.

8. The liquid crystal display device as set forth in claim 1, further comprising:
voltage detection means which detects a reduction in a power supply voltage of said liquid crystal display device,
the control means carrying out the power-off processing in a case where the voltage detection means detects that the power supply voltage becomes a given voltage or less.

9. The liquid crystal display device as set forth in claim 1, wherein:
during image display, the control means causes polarities of voltages, to be applied to source bus lines connected to respective picture elements which are connected to a corresponding one of the gate bus lines, to be reversed for the each gate bus line; and
during power-off processing, the control means causes a polarity of a voltage to be applied to each source bus line to be consistent regardless of a gate bus line, via which writing is carried out.

10. A method of controlling a liquid crystal display device for carrying out writing processing in which a voltage corresponding to image data is applied to each picture element by (a) periodically selecting a gate bus line, via which writing is carried out and (b) controlling, in accordance with the image data, a voltage to be applied to a source bus line connected to the each picture element connected to a selected gate bus line,
said method comprising the step of:
in a case where a power supply to said liquid crystal display device is turned off,
carrying out power-off processing in which (A) a selection switching cycle of gate bus lines, via each of which writing is carried out, is set shorter than a selection switching cycle during image display and (B) a given voltage for power-off processing is applied to each source bus line.

11. A non-transitory computer readable storage medium which stores a program for controlling a liquid crystal display device, said program causing a computer to function as the control means of the liquid crystal display device as set forth in claim 1.
